(19) United States
(12) Patent Application Publication
(10) Pub. No.: US 2025/0285321 A1
(43) Pub. Date: Sep. 11, 2025

(54) INFORMATION PROCESSING APPARATUS, INFORMATION PROCESSING METHOD, AND INFORMATION GENERATION METHOD

(71) Applicant: Sony Semiconductor Solutions Corporation, Kanagawa (JP)

(72) Inventors: Takahiko YOSHIDA, Kanagawa (JP); Tsubasa KUROKAWA, Kanagawa (JP)

(73) Assignee: Sony Semiconductor Solutions Corporation, Kanagawa (JP)

(21) Appl. No.: 18/861,613

(22) PCT Filed: May 11, 2023
(86) PCT No.: PCT/JP2023/017664

§ 371 Date: Oct. 30, 2024

(30) Foreign Application Priority Data
May 12, 2022 (JP) 2022-078633

(51) Int. Cl. G06T 7/73; G06T 7/55; G06V 10/764

(52) U.S. Cl. CPC G06T 7/73; G06T 7/55; G06V 10/764; G06T 2207/10028; G06T 2207/20081

(57) ABSTRACT

A system for generating three-dimensional (3D) point cloud data comprising: at least one first processor configured to generate, based on two-dimensional (2D) image data, the 3D point cloud data, wherein each point of the 3D point cloud data comprises: position information, the position information comprising at least three coordinates indicating a position of the point; object information labeling the point as a first object selected from a plurality of objects; and category information labeling the point as belonging to a first category of a plurality of categories, wherein each of the plurality of categories comprises at least one respective object of the plurality of objects.

### CROSS-REFERENCE TO RELATED APPLICATIONS

This application claims the benefit of Japanese Priority Patent Application JP 2022-078633 filed May 12, 2022, which is herein incorporated by reference in its entirety.

### TECHNICAL FIELD

The present disclosure relates to an information processing apparatus, an information processing method, and an information generation method.

### BACKGROUND ART

Currently, regarding various systems such as automatic driving, augmented reality (AR), and robots (for example, SLAM: simultaneous execution of self-localization and map creation), there is an apparatus that processes an acquired three-dimensional point cloud (3D point cloud) in real time and performs object recognition (classification) for each point of the three-dimensional point cloud (see, for example, Patent Literature 1.). In such a technique, an obstacle, a background object, and the like can be recognized in real time by performing classification using a neural network.

### CITATION LIST

### Patent Literature

[PTL 1] JP 2021-196829 A

### SUMMARY

### Technical Problem

However, in a case where the technology as described above is used, the three-dimensional point cloud data subjected to the class classification defined in advance is required, and thus the processing cost of generating the learning data set is higher than that of the two-dimensional image data set. In addition, in a case where the recognition label of the class classification differs depending on the task, it is necessary to prepare a learning data set and a learned model for each task, and the processing cost increases.

Therefore, the present disclosure proposes an information processing apparatus, an information processing method, and an information generation method capable of reducing the processing cost.

### Solution to Problem

An information processing apparatus according to the embodiment of the present disclosure includes: a recognition unit that executes recognition processing on an image and gives a recognition result for each picture element of the image or each picture element of interest; a classification unit that classifies the recognition result for each picture element of the image or each picture element of interest according to a task and gives a classification result for each picture element of the image or each picture element of interest; and a three-dimensional point cloud generation unit that generates a three-dimensional point cloud related to the image and gives the classification result for each point of the three-dimensional point cloud based on the classification result for each picture element of the image or each picture element of interest.

An information processing method according to the embodiment of the present disclosure includes: executing recognition processing on an image and giving a recognition result for each picture element of the image or each picture element of interest; classifying the recognition result for each picture element of the image or each picture element of interest according to a task and giving a classification result for each picture element of the image or each picture element of interest; and generating a three-dimensional point cloud related to the image and giving the classification result for each point of the three-dimensional point cloud based on the classification result for each picture element of the image or each picture element of interest.

An information generation method according to the embodiment of the present disclosure includes: generating information including position information for each point of three-dimensional point cloud, and a classification result for each point of the three-dimensional point cloud acquired by classifying a recognition result for each point of the three-dimensional point cloud according to a task.

A system for generating three-dimensional (3D) point cloud data, the system comprising: at least one first processor configured to: generate, based on two-dimensional (2D) image data, the 3D point cloud data, wherein each point of the 3D point cloud data comprises: position information, the position information comprising at least three coordinates indicating a position of the point; object information labeling the point as a first object selected from a plurality of objects; and category information labeling the point as belonging to a first category of a plurality of categories, wherein each of the plurality of categories comprises at least one respective object of the plurality of objects.

A method for generating three-dimensional (3D) point cloud data, the method comprising: generating, based on two-dimensional (2D) image data, the 3D point cloud data, wherein each point of the 3D point cloud data comprises: position information, the position information comprising at least three coordinates indicating a position of the point; object information labeling the point as a first object selected from a plurality of objects; and category information labeling the point as belonging to a first category of a plurality of categories, wherein each of the plurality of categories comprises at least one respective object of the plurality of objects.

At least one non-transitory computer-readable storage medium having instructions encoded thereon that, when executed by at least one processor, cause the at least one processor to perform a method for generating three-dimensional (3D) point cloud data, the method comprising: generating, based on two-dimensional (2D) image data, the 3D point cloud data, wherein each point of the 3D point cloud data comprises: position information, the position information comprising at least three coordinates indicating a position of the point; object information labeling the point as a first object selected from a plurality of objects; and category information labeling the point as belonging to a first category of a plurality of categories, wherein each of the plurality of categories comprises at least one respective object of the plurality of objects.

A system comprising: at least one non-transitory computer-readable storage medium having three-dimensional (3D) point cloud data encoded thereon, each point of the 3D point cloud data comprising: position information, the position information comprising at least three coordinates indicating a position of the point; object information labeling the point as a first object selected from a plurality of objects; and category information labeling the point as belonging to a first category of a plurality of categories, wherein each of the plurality of categories comprises at least one respective object of the plurality of objects.

### BRIEF DESCRIPTION OF DRAWINGS

FIG. 1 is a diagram illustrating an example of a schematic configuration of an information processing system according to an embodiment of the present disclosure.

FIG. 2 is a diagram illustrating an example of a schematic configuration of an information processing apparatus according to the embodiment of the present disclosure.

FIG. 3 is a flowchart illustrating an example of flow of information processing according to the embodiment of the present disclosure.

FIG. 4 is a diagram for describing an example of flow of the information processing according to the embodiment of the present disclosure.

FIG. 5 is a diagram for describing a first specific example of recognition label information and category label information according to the embodiment of the present disclosure.

FIG. 6 is a diagram for describing a second specific example of the recognition label information and the category label information according to the embodiment of the present disclosure.

FIG. 7 is a diagram for describing a third specific example of the recognition label information and the category label information according to the embodiment of the present disclosure.

FIG. 8 is a flowchart illustrating an example of flow of 3D point cloud generation processing according to the embodiment of the present disclosure.

FIG. 9 is a diagram for describing the 3D point cloud generation processing according to the embodiment of the present disclosure.

FIG. 10 is a diagram for describing the 3D point cloud generation processing according to the embodiment of the present disclosure.

FIG. 11 is a diagram illustrating an example of a schematic configuration of a modification of an information processing apparatus according to the embodiment of the present disclosure.

FIG. 12 is a diagram for describing a specific example of a graphic user interface (GUI) according to the embodiment of the present disclosure.

FIG. 13 is a diagram illustrating an example of a schematic configuration of hardware according to the embodiment of the present disclosure.

### DESCRIPTION OF EMBODIMENTS

Hereinafter, embodiments of the present disclosure will be described in detail with reference to the drawings. Note that the apparatus, the system, the method, and the like according to the present disclosure are not limited by the embodiment. In addition, in each of the following embodiments, the same parts are basically denoted by the same reference numerals, and redundant description will be omitted.

One or more embodiments (including examples and modifications) described below can each be implemented independently. On the other hand, at least a part of the plurality of embodiments described below may be appropriately combined with at least some of other embodiments. The plurality of embodiments may include novel features different from each other. Therefore, the plurality of embodiments can contribute to solving different objects or problems, and can exhibit different effects.

In addition, the present disclosure will be described according to the following item order.
1. Embodiment
1-1. Configuration example of information processing system
1-2. Configuration example of information processing apparatus
1-3. Example of information processing
1-4. Specific example of recognition label information and category label information
1-5. Example of 3D point cloud generation processing
1-6. Action and effect
2. Another configuration example of information processing apparatus
3. Specific example of GUI
4. Other embodiments
5. Configuration example of hardware
6. Appendix

### 1. Embodiment

### <1-1. Configuration Example of Information Processing System>

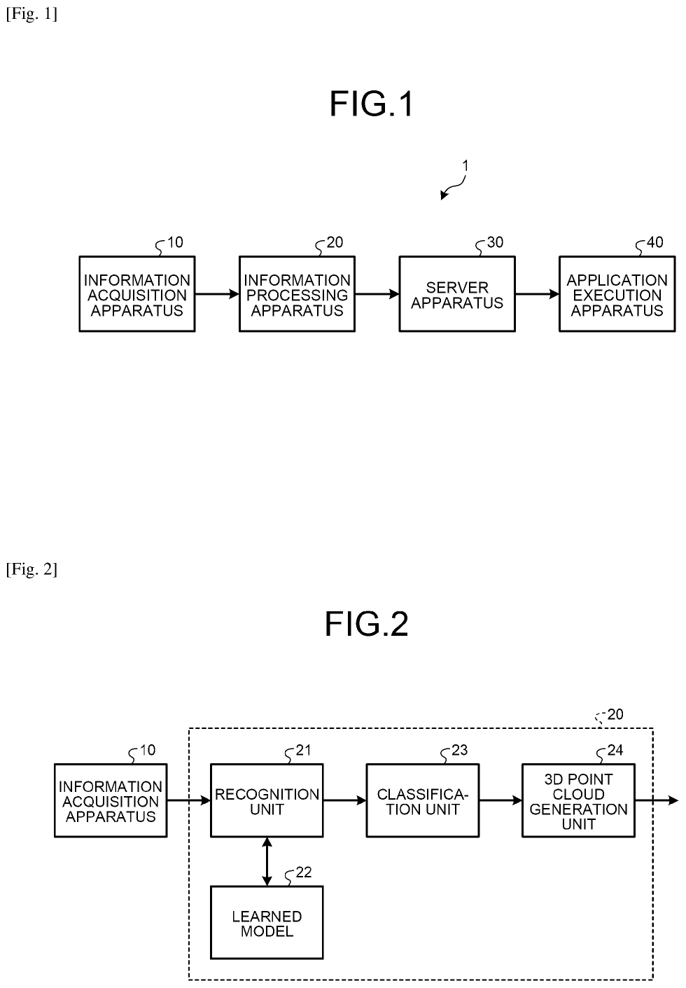

A configuration example of an information processing system 1 according to the present embodiment will be described with reference to FIG. 1. FIG. 1 is a diagram illustrating an example of a schematic configuration of the information processing system 1 according to the present embodiment of the present disclosure.

As illustrated in FIG. 1, an information processing system 1 according to the present embodiment includes an information acquisition apparatus 10, an information processing apparatus 20, a server apparatus 30, and an application execution apparatus (application execution apparatus) 40.

The information acquisition apparatus 10 is, for example, an apparatus that acquires image information, distance information, and the like related to an image of a target object, and transmits the acquired image information, distance information, and the like to the information processing apparatus 20. The information acquisition apparatus 10 is realized by, for example, an imaging sensor such as an RGB sensor or an image sensor, or a distance measuring sensor such as a stereo camera or an indirect time of flight (iToF) sensor.

For example, the imaging sensor receives ambient light by a photodiode, detects RGB values, and acquires a color image. The stereo camera measures a distance to a target object (information in a depth direction of the target object) by photographing the target object with the camera from a plurality of different directions. The iToF sensor irradiates a target object with periodic laser light (continuous wave), and measures a distance to the target object from a phase shift of reflected light from the target object. However, the information acquisition apparatus 10 may be a sensor other than the imaging sensor and the distance measuring sensor.

Here, in the imaging sensor, for example, a plurality of 2D images (two-dimensional images) is acquired. In this case, as the 2D image of the target object, for example, two or more 2D image groups photographed to have an overlapping region are acquired. In addition, in the distance measuring sensor, for example, a depth image (depth map) having depth information (distance information) for each picture element is acquired. The depth image may be generated at least in part using a depth sensor. In some embodiments, the depth image is generated at least in part based on first and second sets of 2D image data that have respective fields of view that at least partially overlap.

The information processing apparatus 20 executes recognition processing on the image according to the image information, the distance information, and the like transmitted from the information acquisition apparatus 10, gives a recognition result (for example, a recognition label indicating a recognition result, also referred to herein as object information) for each picture element of the image, classifies the recognition result for each picture element of the image according to the task, and gives a category result (for example, a category label indicating a classification result, also referred to herein as category information) for each picture element. Furthermore, the information processing apparatus 20 generates a 3D point cloud having a classification result for each 3D point (three-dimensional point) based on the distance information, the classification result for each picture element of the image, and the like, and transmits the point cloud information related to the 3D point cloud to the server apparatus 30.

Here, the 3D point cloud is, for example, a sample of a position and a spatial structure of a target object (object). Normally, the 3D point cloud data is acquired for each frame time of a constant cycle. By performing various types of arithmetic processing on the 3D point cloud data, it is possible to detect (recognize) an accurate position, posture, and the like of the target object.

The information processing apparatus 20 is realized by a processor such as a central processing unit (CPU) or a micro processing unit (MPU), for example. For example, the information processing apparatus 20 is realized by a processor executing various programs using a random access memory (RAM) and the like as a work region. Note that the information processing apparatus 20 may be realized by an integrated circuit such as an application specific integrated circuit (ASIC) or a field programmable gate array (FPGA). Any of the CPU, the MPU, the ASIC, and the FPGA can be regarded as a controller. In addition, the information processing apparatus 20 may be realized by a graphics processing unit (GPU) in addition to or in place of the CPU. In addition, the information processing apparatus 20 may be realized by specific software instead of specific hardware.

The server apparatus 30 stores and manages various types of information. For example, the server apparatus 30 stores and manages the point cloud information transmitted from the information processing apparatus 20. The server apparatus 30 is realized by, for example, a server such as a cloud server, a PC server, a midrange server, or a mainframe server.

Here, transmission and reception of data with the server apparatus 30 are executed via, for example, a network. The network is, for example, a communication network (communication linkage) such as a local area network (LAN), a wide area network (WAN), a cellular network, a fixed telephone linkage, a regional Internet protocol (IP) linkage, or the Internet. The network may include a wired network or a wireless network. In addition, the network may include a core network. The core network is, for example, an evolved packet core (EPC) or a 5G core network (5GC). In addition, the network may include a data network other than the core network. For example, the data network may be a service network of a telecommunications carrier, for example, an IP Multimedia Subsystem (IMS) network. In addition, the data network may also be a private network, such as an intra-company network.

Note that, as a radio access technology (RAT), long term evolution (LTE), new radio (NR), Wi-Fi (registered trademark), Bluetooth (registered trademark), and the like can be used. Several types of radio access technologies may be used, for example, NR and Wi-Fi may be used, and LTE and NR may be used. LTE and NR are a type of cellular communication technology, and enable mobile communication by arranging a plurality of areas covered by a base station in a cell shape.

The application execution apparatus 40 executes the application using the point cloud information transmitted from the server apparatus 30. As the application, for example, various applications such as a general-purpose application and a dedicated application can be used.

Similarly to the information processing apparatus 20, the application execution application execution apparatus 40 is realized by a processor such as a CPU or an MPU, for example. For example, the application execution apparatus 40 is realized by a processor executing various programs using a RAM and the like as a work region. Note that the application execution application execution apparatus 40 may be realized by an integrated circuit such as an ASIC or an FPGA. In addition, the application execution application execution apparatus 40 may be realized by a GPU in addition to or instead of the CPU. In addition, the application execution apparatus 40 may be realized by specific software instead of specific hardware.

Here, the application execution application execution apparatus 40 is mounted on various apparatuses such as a car, a robot, and a user terminal. However, in addition to the application execution apparatus 40, one or both of the information acquisition apparatus 10 and the information processing apparatus 20 may be appropriately mounted on the various apparatuses. The user terminal is a terminal used by the user, and receives the point cloud information from the server apparatus 30, for example. The user terminal is realized by, for example, a terminal such as a personal computer (for example, a notebook computer or a desktop computer), a smart device (for example, a smartphone or a tablet), or a personal digital assistant (PDA). In addition, the user terminal may be realized by, for example, an xR device such as an augmented reality (AR) device, a virtual reality (VR) device, or a mixed reality (MR) device. The xR device may be a glasses-type device (for example, AR/MR/VR glasses) or a head-mounted or goggle-type device (for example, AR/MR/VR headsets, AR/MR/VR goggles). These xR devices may display a video of only one eye or may display videos of both eyes.

Note that the application execution apparatus 40 receives the point cloud information from the information processing apparatus 20 via the server apparatus 30, but is not limited to this, and for example, may directly receive the point cloud information from the information processing apparatus 20 without via the server apparatus 30. This is appropriately selected according to the configuration, use, and the like of various apparatuses on which the application execution apparatus 40 is mounted.

### <1-2. Configuration Example of Information Processing Apparatus>

A configuration example of the information processing apparatus 20 according to the present embodiment will be described with reference to FIG. 2. FIG. 2 is a diagram illustrating an example of a schematic configuration of the information processing apparatus 20 according to the present embodiment.

As illustrated in FIG. 2, the information processing apparatus 20 includes a recognition unit 21, a learned model 22, a classification unit 23, and a 3D point cloud generation unit (three-dimensional point cloud generation unit) 24.

The recognition unit 21 executes recognition processing on the image and gives a recognition result for each picture element of the image. For example, the recognition unit 21 executes recognition processing of recognizing an attribute of a picture element for each picture element, and gives a recognition result (for example, a recognition label). The recognition result is a result of identifying what the target object is, and indicates, for example, a car, a person, a building, and the like. For example, the recognition unit 21 gives a recognition label for each picture element based on the learned model 22. Note that the recognition unit 21 may give a recognition label for each picture element of interest instead of each picture element. The picture element of interest is not all the picture elements of the image, but is, for example, a specific picture element set in advance.

The learned model 22 is a recognition label learned model that determines any recognition label from a plurality of types of recognition labels as a recognition result. The learned model 22 is, for example, a model that uses data given in advance by a recognition label (correct answer label) as teacher data, learns a neural network (for example, CNN: convolutional neural network, and the like), which is one of machine learning that recognizes a target object from an image, and executes recognition processing on the image to give a recognition label for each picture element of the image.

The classification unit 23 classifies the recognition result for each picture element of the image according to the task, and gives a classification result (for example, a category label) for each picture element of the image. The classification result is a result of identifying which category the recognition result is classified into, and indicates, for example, category 1, category 2, category 3, and the like. The classification may be performed using a learned model, such as a machine learning model. Note that examples of the task include various tasks such as a task for which a region of earth and sand is desired to be known and a task for which a vehicle region is desired to be known.

The 3D point cloud generation unit 24 generates a 3D point cloud (also referred to herein as 3D point cloud data) having a classification result for each 3D point based on the distance information related to the image and the classification result for each picture element of the image. The 3D point cloud is a set of points having position information (for example, three-dimensional coordinates X, Y, Z), and has a classification result for each position.

For example, the 3D point cloud generation unit 24 generates a 3D point cloud based on the distance information for each picture element of a 2D image group (e.g., multiple sets of 2D image data such as first and second sets of 2D image data) or a depth image. Note that, as a method of generating a 3D point cloud from a 2D image group, for example, stereo matching or structure from motion (SfM) and multi-view stereo (MVS) are used. The SfM generates low-density point cloud data restored from the feature point by triangulation. The MVS generates high-density point cloud data.

Note that each block (for example, the recognition unit 21, the learned model 22, the classification unit 23, and the 3D point cloud generation unit 24) constituting the information processing apparatus 20 described above is a functional block indicating a function of the information processing apparatus 20. These functional blocks may be software blocks or hardware blocks. For example, each block may be one software module realized by software (microprograms) or one circuit block on a semiconductor chip (die). Of course, each block may be one processor or one integrated circuit. In addition, the information processing apparatus 20 may include a functional unit different from each of the above blocks. A configuration method of each block is arbitrary. In addition, a part or all of the operations of each block may be performed by another apparatus.

### <1-3. Example of Information Processing>

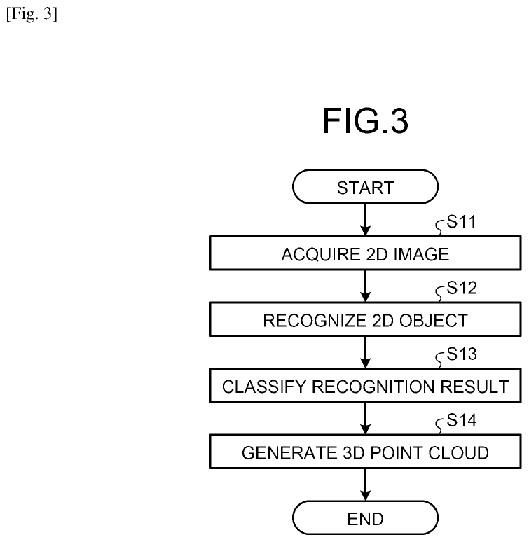

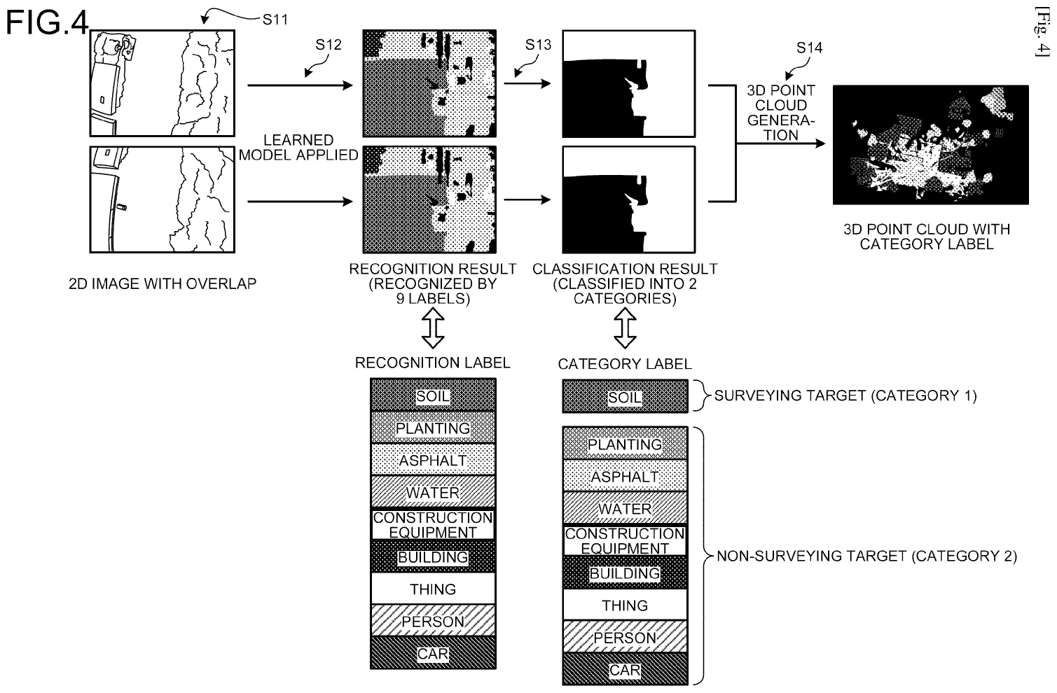

An example of the information processing according to the present embodiment will be described with reference to FIGS. 3 and 4. FIG. 3 is a flowchart illustrating an example of flow of information processing according to the embodiment of the present embodiment. FIG. 4 is a diagram for describing an example of flow of the information processing according to the embodiment of the present embodiment.

As illustrated in FIG. 3, in step S11, the information acquisition apparatus 10 continuously performs photographing in a manner that there is an overlapping region, and acquires a plurality of 2D images (for example, a color image). In step S12, the recognition unit 21 performs object recognition processing on each 2D image, and gives a recognition result (for example, a recognition label) for each picture element of each 2D image. In step S13, the classification unit 23 classifies the recognition result for each picture element of each 2D image, and gives the classification result (for example, a category label) for each picture element of each 2D image. In step S14, the 3D point cloud generation unit 24 generates a 3D point cloud having a classification result (for example, category 1, category 2, and the like) for each 3D point.

As illustrated in FIG. 4, in step S11, an image group photographed to have an overlapping region (overlap), that is, two or more 2D images are acquired. In this case, the information acquisition apparatus 10 is mounted on a moving body such as a drone, an airplane, or a helicopter on which an aerial camera is mounted, for example. The transmission of the image information may be realized by, for example, a radio access technology such as Wi-Fi (registered trademark).

Next, in step S12, the learned model 22 is used, recognition processing is executed on each 2D image, and a recognition label is given for each picture element of each 2D image. As a result, in each 2D image, a recognition label map having a recognition label for each picture element is generated (also referred to herein as a category label map). The recognition label map is an N-value image that is a 2D segmentation result. In the example of FIG. 4, the recognition labels include “soil”, “planting”, “asphalt”, “water”, “construction equipment”, “building”, “thing”, “person”, and “car”. In this case, since there are nine recognition labels, the recognition label map is indicated by nine colors and becomes a nine-value image (N=9).

Next, in step S13, the recognition label for each picture element of each 2D image is classified according to the task, and a category label (classification label) is given for each picture element of these 2D images. As a result, a category label map having a category label for each picture element is generated. The category label map is an M-value image that is a 2D segmentation result (where M<N). In the example of FIG. 4, as category labels corresponding to tasks, there are a surveying target (category 1) and a non-surveying target (category 2). A surveying target is “soil”, and non-surveying targets are “planting”, “asphalt”, “water”, “construction equipment”, “building”, “thing”, “person”, and “car”. In this case, since the recognition label for each picture element of each 2D image is classified into two categories, the category label map is indicated by two colors (for example, white and black) and becomes a binary image (M=2).

Finally, in step S14, a 3D point cloud having a category label for each point of the 3D point cloud, that is, a 3D point cloud with a category label is generated. For example, a 3D point cloud is generated, a category label is given for each point of the 3D point cloud, and a 3D point cloud with a category label is generated. In this category label giving, the category label for each picture element of the 2D image is given to the 3D point cloud corresponding to each picture element. Such 3D point cloud generation processing will be described later in detail. Note that, in the example of FIG. 4, there are various filled regions such as a black solid filled region and a dot filled region, and these different filled regions indicate that the types (for example, category 1, category 2, etc.) of the category labels are different.

Here, for example, in a case where a recognition label of a certain picture element is “soil” in step S13, the recognition label is classified into a surveying target (category 1), and “category 1” is given to the picture element as a category label. In addition, in a case where the recognition label of another picture element is “planting”, the recognition label is classified as non-surveying target (category 2), and “category 2” is given to the picture element as a category label. Such processing is performed on all the picture elements, and a category label is given for each picture element. After that, in step S14, “category 1” is given as the category label to the 3D point corresponding to the picture element to which “category 1” is given. In addition, “category 2” is given as the category label to the 3D point corresponding to the picture element to which “category 2” is given. Such processing is performed on all the picture elements, and a category label is given for each 3D point cloud. Note that the 3D point corresponding to a certain picture element is, for example, a 3D point at the position of the 3D coordinates calculated by calculating the 3D coordinates of the picture element.

According to such a series of information processing, a recognition processing is executed on a plurality of 2D images that is a source of 3D point cloud generation, and after that, a classification processing of classifying a recognition label for each picture element of each 2D image according to a task is executed, and a category label is given for each picture element of each 2D image. In the recognition processing, a learned model 22 including all assumed recognition labels is prepared, and the recognition processing is executed based on the learned model 22. Normally, a learned model for each task is prepared, and when the task changes, recognition processing by the learned model corresponding to the task is executed. However, according to the present embodiment, when the task changes, classification processing according to the task is executed. That is, even if the task is changed, the classification processing according to the task is executed, in a manner that the point cloud information according to various tasks can be generated. Note that, in the classification processing, a correspondence relationship indicating which category is necessary for each task, that is, category label information for each task is prepared.

### <1-4. Specific Example of Recognition Label Information and Category Label Information>

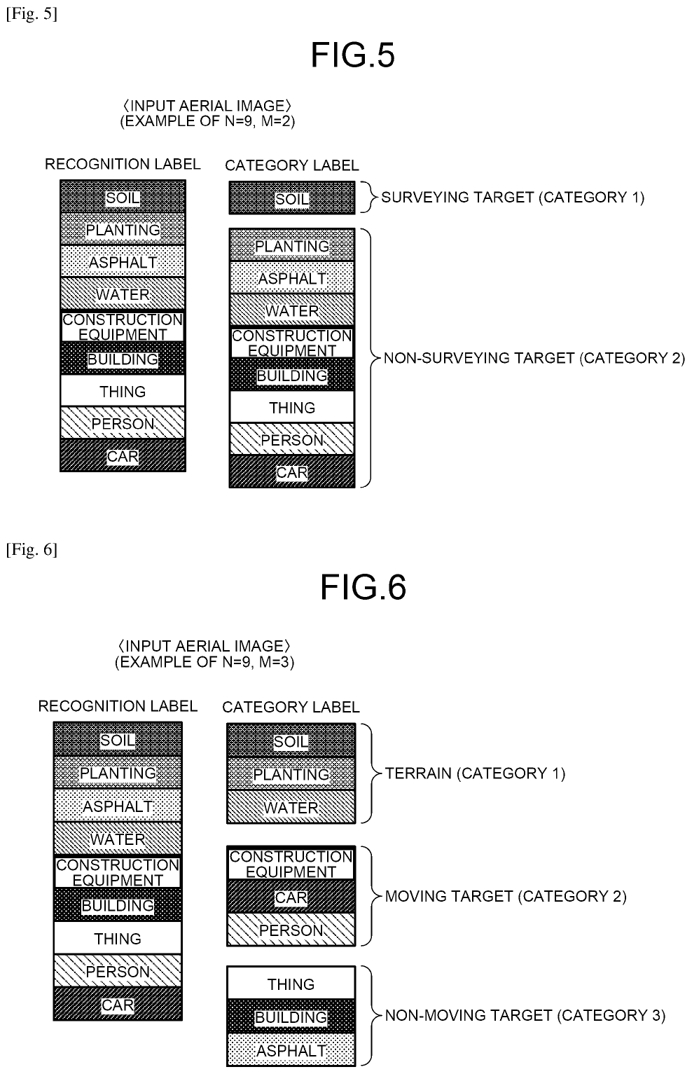

Specific examples of the recognition label information and the category label information according to the present embodiment will be described with reference to FIGS. 5 to 7. FIGS. 5 to 7 are diagrams for describing a specific example of recognition label information and category label information.

In the recognition processing and classification processing (see steps S12 and S13 in FIG. 4), the 2D image is used as input data, the recognition label map (N-value image) is intermediately output, and the category label map (M-value image, where M<N) is output. In the first specific example and the second specific example, the input 2D image is an aerial image, and in the third specific example, the input 2D image is an in-vehicle image. Note that the 2D image may be an RGB color image or gray scale.

As illustrated in FIG. 5, in the first specific example (example of input aerial image: N=9, M=2), there are nine types of recognition labels, which are “soil”, “planting”, “asphalt”, “water”, “construction equipment”, “building”, “thing”, “person”, and “car”. There are two types of category labels, which are a surveying target (category 1) and a non-surveying target (category 2). In the example of FIG. 5, a surveying target is “soil”, and non-surveying targets are “planting”, “asphalt”, “water”, “construction equipment”, “building”, “thing”, “person”, and “car”.

As illustrated in FIG. 6, in the second specific example (example of input aerial image: N=9, M=3), similarly to FIG. 5, there are nine types of recognition labels, which are “soil”, “planting”, “asphalt”, “water”, “construction equipment”, “building”, “thing”, “person”, and “car”. There are three types of category labels, which are terrain (category 1), a moving target (category 2), and a non-moving target (category 3). In the example of FIG. 6, terrain is “soil”, “planting”, and “water”, moving targets are “construction equipment”, “car”, and “person”, and non-moving targets are “thing”, “building”, and “asphalt”.

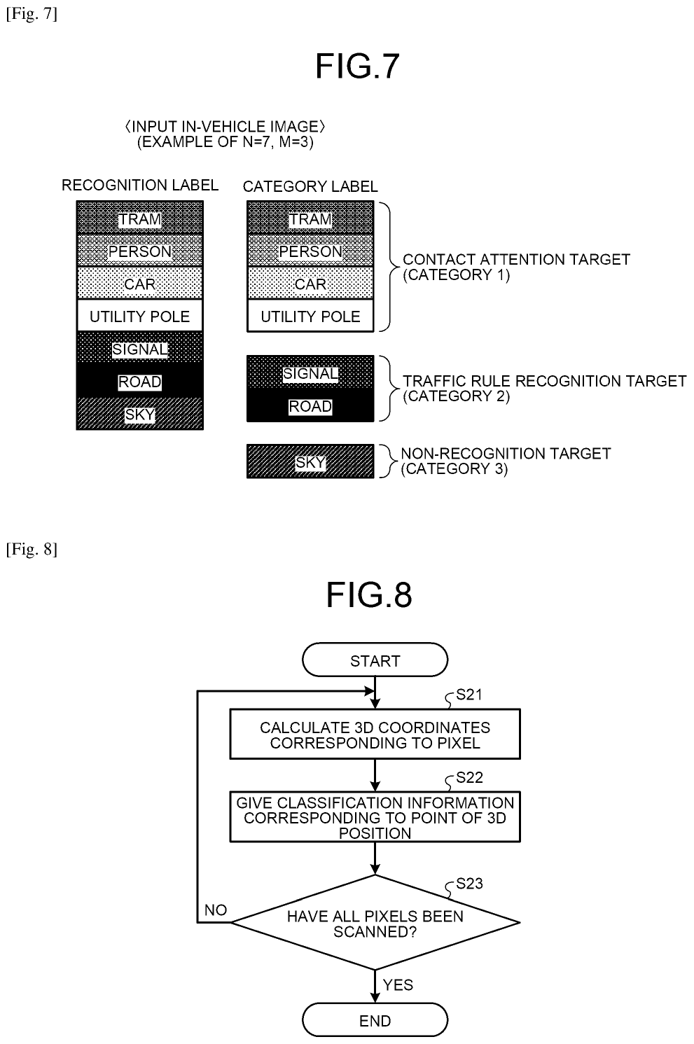

As illustrated in FIG. 7, in the third specific example (example of input in-vehicle image: N=7, M=3), there are seven types of recognition labels, which are “tram”, “person”, “car”, “utility pole”, “signal”, “road”, and “sky”. There are three types of category labels, which are contact attention target (category 1), traffic rule recognition target (category 2), and non-recognition target (category 3). In the example of FIG. 7, the contact attention targets are “tram”, “person”, “car”, and “utility pole”, the traffic rule recognition targets are “signal” and “road”, and the non-recognition target is “sky”.

According to the first specific example, the second specific example, and the third specific example, the category label information indicating the relationship between the recognition label and the category label may be set for a specific task, or may be set for each task. In a case where the category label information is set for each task, the category label information is selected according to the task and used for the classification processing. By preparing the category label information for each task in this manner, it is possible to cope with various tasks. Conventionally, it is necessary to prepare the learned model 22 for each task, but according to the present embodiment, if one learned model 22 is prepared, a recognition result based on the learned model 22 is converted into a classification result according to the task, in a manner that it is possible to cope with various tasks.

Note that the specific examples according to FIGS. 5 to 7 are merely examples, and category label information corresponding to other tasks can also be used. For example, the classification unit 23 may store the category label information for each task in the storage unit. The storage unit may be provided in the classification unit 23 or may be provided outside the classification unit 23. The storage unit is realized by, for example, a storage apparatus capable of reading and writing data, such as a dynamic random access memory (DRAM), a static random access memory (SRAM), a flash memory, or a hard disk.

### <1-5. Example of 3D Point Cloud Generation Processing>

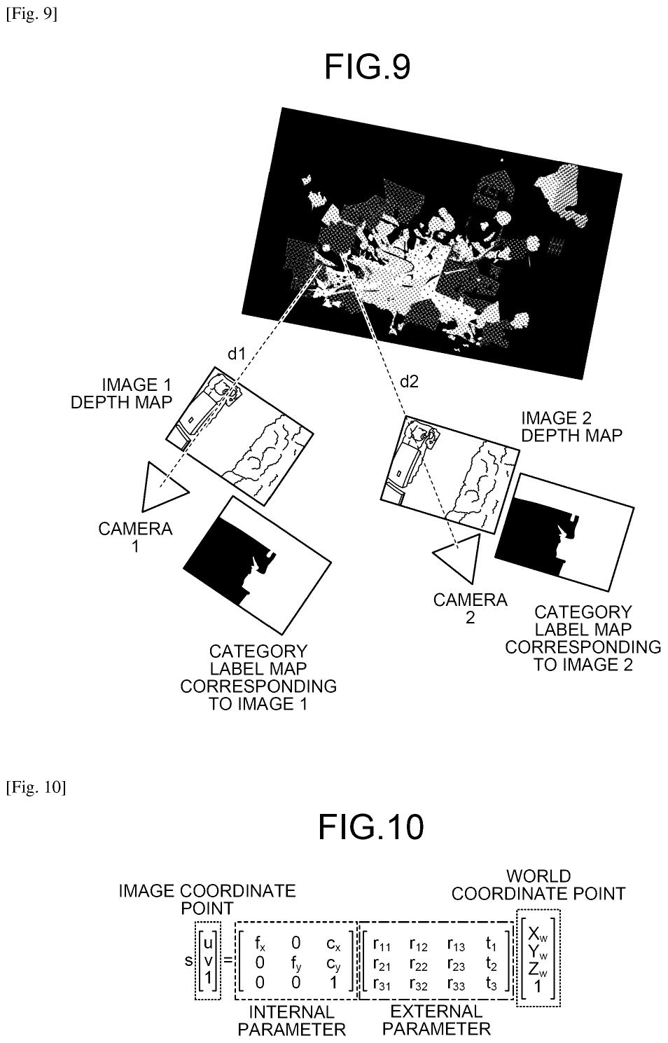

An example of 3D point cloud generation processing according to the present embodiment will be described with reference to FIGS. 8 to 10. FIG. 8 is a flowchart illustrating an example of flow of 3D point cloud generation processing according to the present embodiment. FIGS. 9 and 10 are diagrams for describing the 3D point cloud generation processing according to the present embodiment.

As illustrated in FIG. 8, in step S21, the 3D point cloud generation unit 24 calculates 3D coordinates corresponding to a pixel (picture element). In step S22, the 3D point cloud generation unit 24 gives a classification result (for example, a category label) corresponding to the point (three-dimensional point) at the 3D position based on the 3D coordinates. In step S23, the 3D point cloud generation unit 24 determines whether or not all the pixels have been scanned, returns the processing to step S21 when determining that all the pixels have not been scanned (No in step S23), and ends the processing when determining that all the pixels have been scanned (Yes in step S23).

In such processing, as illustrated in FIG. 9, two or more category label maps (M-value images), depth images corresponding to these maps, and photographing position information corresponding to each image are input. The depth image is an image having a depth value (for example, d1, d2, and the like) as distance information for each picture element. The photographing position information is the position of the photographed camera, and is, for example, information indicating that the camera has been calibrated. A 3D point cloud with a category label is generated based on these pieces of information, and point cloud information related to the 3D point cloud is output.

Here, the point cloud information is configured in a data format including at least (X, Y, Z, C) for each point of the 3D point cloud. XYZ is a 3D coordinate of the 3D point, and C is a category label value (for example, category 1, category 2, category 3, and the like). That is, the point cloud information includes at least the position information (X, Y, Z) and the classification result information (C) for each point of the 3D point cloud.

In addition, the point cloud information may be in a format reflecting color information of the original image, for example. That is, the point cloud information may be configured in a data format including at least (X, Y, Z, R, G, B, C) for each point of the 3D point cloud. RGB is color information (for example, 256-value) of a point. That is, the point cloud information may include, for example, position information (X, Y, Z), color information (R, G, B), and classification result information (C) for each point of the 3D point cloud.

Note that, regarding the camera calibration described above, as illustrated in FIG. 10, the relationship between the coordinate point of the image and the world coordinate point (3D position) is described by an internal parameter matrix and an external parameter matrix. For example, the 3D position (world coordinate point) as the camera position is determined by the relational expression. In the example of FIG. 10, the internal parameter is conversion from the camera coordinate system to the image coordinate system. The external parameter is conversion from the world coordinate system to the camera coordinate system. The internal parameter and the external parameter are, for example, parameters of the perspective projection model.

### <1-6. Action and Effect>

As described above, according to the present embodiment, the information processing apparatus 20 includes: the recognition unit 21 that executes recognition processing on an image and gives a recognition result (for example, a recognition label) for each picture element of the image or each picture element of interest; the classification unit 23 that classifies the recognition result (for example, a category label) for each picture element of the image or each picture element of interest according to a task and gives a classification result for each picture element of the image or each picture element of interest; and the 3D point cloud generation unit 24 that generates a 3D point cloud related to the image and gives the classification result for each point of the 3D point cloud based on the classification result for each picture element of the image or each picture element of interest. As a result, after the recognition processing, the classification processing of classifying the recognition result for each picture element of the image or each picture element of interest is executed according to the task, and the classification result is given for each picture element of the image or each picture element of interest. Therefore, for example, in a case where the task is changed, it is only necessary to perform the classification processing according to the task without performing the re-execution of the recognition processing which is conventionally necessary, and the processing cost can be suppressed.

In addition, the recognition unit 21 may execute recognition processing on a plurality of 2D images that are images, and may give the recognition result for each picture element of each 2D image or each picture element of interest, the classification unit 23 may classify the recognition result for each picture element of each 2D image or each picture element of interest, and may give the classification result for each picture element of each 2D image or each picture element of interest, and the 3D point cloud generation unit 24 may generate the 3D point cloud based on distance information for each picture element of each 2D image or each target picture element, and may give the classification result for each point of the 3D point cloud based on the classification result for each picture element of the plurality of 2D images or each target picture element. As a result, a 3D point cloud having a classification result for each 3D point can be reliably generated.

In addition, the recognition unit 21 may execute recognition processing on a depth image that is the image, and may give the recognition result for each picture element of the depth image or each picture element of interest, the classification unit 23 may classify the recognition result for each picture element of the depth image or each picture element of interest, and may give the classification result for each picture element of the depth image or each picture element of interest, and the 3D point cloud generation unit 24 may generate the 3D point cloud based on distance information for each picture element of the depth image or each target picture element, and may give the classification result for each point of the 3D point cloud based on the classification result for each picture element of the depth image or each target picture element. As a result, a 3D point cloud having a classification result for each 3D point can be reliably generated.

In addition, the recognition unit 21 may give a determined recognition label for each picture element of the image or each picture element of interest based on the learned model 22 that determines one recognition label from a plurality of types of recognition labels indicating the recognition result as the recognition result. As a result, the recognition label can be reliably given for each picture element of the image or each picture element of interest.

In addition, the recognition unit 21 may give a recognition label indicating the recognition result as the recognition result, the classification unit 23 may give a category label indicating the classification result as the classification result, and a type of the category label may be less than a type of the recognition label. For example, there may be fewer possible category labels than possible recognition labels. As a result, the processing cost can be reliably suppressed.

In addition, the classification unit 23 may generate a category label map having the category label for each picture element of the image or each picture element of interest, and the 3D point cloud generation unit 24 may give the category label for each point of the 3D point cloud based on the category label map. As a result, a 3D point cloud having a category label for each 3D point can be reliably generated.

In addition, the classification unit 23 may select one category label information from the category label information for each task indicating a relationship between the recognition label and the category label, and may give the category label for each picture element of the image or each picture element of interest based on the selected category label information. As a result, a 3D point cloud having a category label for each 3D point can be reliably generated.

### 2. Another Configuration Example of Information Processing Apparatus

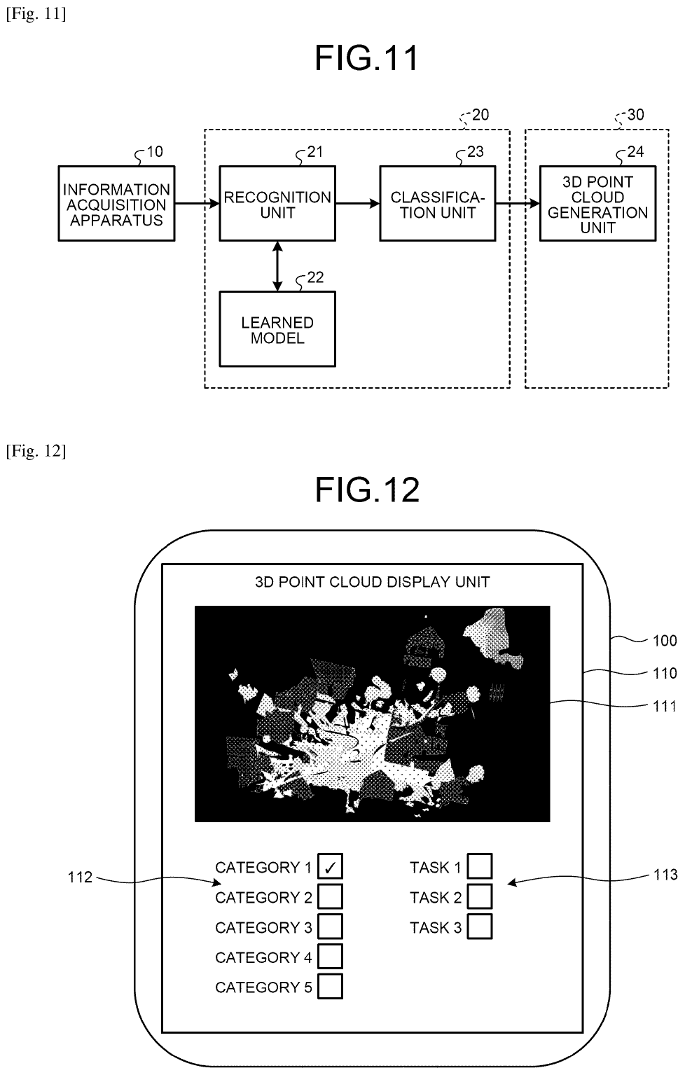

Another configuration example of the information processing apparatus 20 according to the above embodiment will be described with reference to FIG. 11. FIG. 11 is a diagram illustrating an example of a schematic configuration of a modification of the information processing apparatus 20 according to the embodiment.

As illustrated in FIG. 11, the information processing apparatus 20 may include the recognition unit 21, the learned model 22, and the classification unit 23, and the server apparatus 30 may include the 3D point cloud generation unit 24. According to such a configuration, heavy 3D point cloud generation processing can be performed on the side of the server apparatus 30 (for example, a cloud server) with abundant calculation resources. Note that at least the category label map (M-value image) is transmitted from the information processing apparatus 20 to the server apparatus 30. For example, a plurality of category label maps is transmitted.

### 3. Specific Example of GUI

A specific example of a GUI (graphic user interface) according to the embodiment will be described with reference to FIG. 12. FIG. 12 is a diagram for describing a specific example of the GUI according to the embodiment.

As illustrated in FIG. 12, a user terminal 100 includes a display unit 110. The display unit 110 is, for example, a liquid crystal display or an organic electro luminescence (EL) display, and a touch panel is adopted as the display unit 110.

The display unit 110 includes a display region 111, a category selection GUI 112, and a task selection GUI 113. The display unit 110 displays the 3D point cloud in the display region 111 based on the point cloud information. The category selection GUI 112 includes a plurality of check boxes for selecting a target category. The user checks the check box and selects one or more target categories. In the example of FIG. 12, there are categories 1 to 5 and the like as the category. Note that the category selection corresponds to setting a task including the selected category. The task selection GUI 113 includes a plurality of check boxes for selecting a target task, not a category. The user checks the check box and selects one or more target tasks. When a task is selected, a target category corresponding to the task is automatically set. In the example of FIG. 12, there are tasks 1 to 3 as the task.

The user operates the category selection GUI 112 to select a target category, or operates the task selection GUI 113 to select a target task. In some embodiments, a selection of a target object may be made. In response to this, for example, the user terminal 100 transmits information such as a target category, target object, or task to the information processing apparatus 20 via the server apparatus 30. The 3D point cloud generation unit 24 receives the transmitted information such as the category, object, and/or task of the target, and transmits the 3D point cloud corresponding to the category, object, and/or task of the target, that is, the point cloud information related to the 3D point cloud having the classification result (for example, a category label) and/or the recognition result (for example, a recognition label) for each point to the user terminal 100 via the server apparatus 30. After that, the display unit 110 displays the 3D point cloud in the display region 111 based on the transmitted point cloud information. In this manner, the 3D point cloud generated according to the selection of the target is displayed.

### 4. Other Embodiments

The processing according to the above embodiment (or modification) may be performed in various different modes (modifications) other than the above embodiments. For example, among the processings described in the above embodiments, all or a part of the processings described as being automatically performed can be manually performed, or all or a part of the processings described as being manually performed can be automatically performed by a known method. In addition, the processing procedure, specific name, and information including various data and parameters illustrated in the document and the drawings can be arbitrarily changed unless otherwise specified. For example, the various types of information illustrated in each figure are not limited to the illustrated information.

In addition, each component of each apparatus illustrated in the drawings is functionally conceptual, and is not necessarily physically configured as illustrated in the drawings. That is, a specific form of distribution and integration of each apparatus is not limited to the illustrated form, and all or a part of it can be functionally or physically distributed and integrated in an arbitrary unit according to various loads, usage conditions, and the like.

In addition, the above embodiments (or modifications) can be appropriately combined within a range that does not contradict processing contents. In addition, the effects described in the present specification are merely examples and are not limited, and other effects may be provided.

### 5. Configuration Example of Hardware

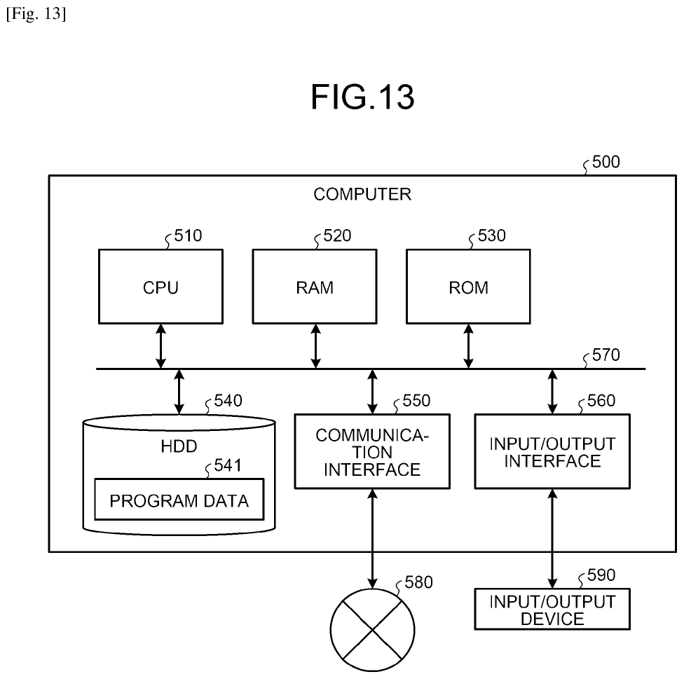

A specific hardware configuration example of the information device such as the information processing apparatus 20, the server apparatus 30, and the application execution apparatus 40 according to the above embodiment (or modification) will be described. The information device such as the information processing apparatus 20, the server apparatus 30, and the application execution apparatus 40 according to the embodiment (or the modification) may be realized by, for example, a computer 500 having a configuration as illustrated in FIG. 13. FIG. 13 is a diagram illustrating an example of a schematic configuration of hardware that realizes functions of the information device.

As illustrated in FIG. 13, the computer 500 includes a CPU 510, a RAM 520, a read only memory (ROM) 530, a hard disk drive (HDD) 540, a communication interface 550, and an input/output interface 560. Each unit of the computer 500 is connected by a bus 570.

The CPU 510 operates based on the program stored in the ROM 530 or the HDD 540, and controls each unit. For example, the CPU 510 develops a program stored in the ROM 530 or the HDD 540 in the RAM 520, and executes processing corresponding to various programs.

The ROM 530 stores a boot program such as a basic input output system (BIOS) executed by the CPU 510 when the computer 500 is activated, a program depending on hardware of the computer 500, and the like.

The HDD 540 is a recording medium that can be read by the computer 500 and performs non-transient recording of a program executed by the CPU 510, data used by such a program, and the like. Specifically, the HDD 540 is a recording medium that records an information processing program according to the present disclosure as an example of program data 541.

The communication interface 550 is an interface for the computer 500 to connect to an external network 580 (for example, the Internet). For example, the CPU 510 receives data from another device or transmits data generated by the CPU 510 to another device via the communication interface 550.

The input/output interface 560 is an interface for connecting an input/output device 590 and the computer 500. For example, the CPU 510 receives data from an input device such as a keyboard or a mouse via the input/output interface 560. In addition, the CPU 510 transmits data to an output device such as a display, a speaker, or a printer via the input/output interface 560.

Note that, in addition, the input/output interface 560 may function as a media interface that reads a program and the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, and the like.

Here, for example, in a case where the computer 500 functions as an information device such as the information processing apparatus 20, the server apparatus 30, or the application execution apparatus 40 according to each embodiment (or modification), the CPU 510 of the computer 500 executes the information processing program loaded on the RAM 520 to realize all or a part of the functions of the respective units such as the information processing apparatus 20, the server apparatus 30, or the application execution apparatus 40 according to each embodiment (or modification). In addition, the HDD 540 stores information processing programs and data according to each embodiment. Note that the CPU 510 reads the program data 541 from the HDD 540 and executes the program data, but as another example, these programs may be acquired from another apparatus via the external network 580.

### 6. Appendix

Note that the present technology can also have the configuration below.
(1) An information processing apparatus comprising: a recognition unit that executes recognition processing on an image and gives a recognition result for each picture element of the image or each picture element of interest; a classification unit that classifies the recognition result for each picture element of the image or each picture element of interest according to a task and gives a classification result for each picture element of the image or each picture element of interest; and a three-dimensional point cloud generation unit that generates a three-dimensional point cloud related to the image and gives the classification result for each point of the three-dimensional point cloud based on the classification result for each picture element of the image or each picture element of interest.
(2) The information processing apparatus according to (1), wherein the recognition unit executes recognition processing on a plurality of two-dimensional images that are the images, and gives the recognition result for each picture element of the plurality of two-dimensional images or each picture element of interest, the classification unit classifies the recognition result for each picture element of the plurality of two-dimensional images or each picture element of interest, and gives the classification result for each picture element of the plurality of two-dimensional images or each picture element of interest, and the three-dimensional point cloud generation unit generates the three-dimensional point cloud based on distance information for each picture element of the plurality of two-dimensional images or each picture element of interest, and gives the classification result for each point of the three-dimensional point cloud based on the classification result for each picture element of the plurality of two-dimensional images or each picture element of interest.
(3) The information processing apparatus according to (1), wherein the recognition unit executes recognition processing on a depth image that is the image, and gives the recognition result for each picture element of the depth image or each picture element of interest, the classification unit classifies the recognition result for each picture element of the depth image or each picture element of interest, and gives the classification result for each picture element of the depth image or each picture element of interest, and the three-dimensional point cloud generation unit generates the three-dimensional point cloud based on distance information for each picture element of the depth image or each target picture element, and gives the classification result for each point of the three-dimensional point cloud based on the classification result for each picture element of the depth image or each target picture element.
(4) The information processing apparatus according to any of (1) to (3), wherein the recognition unit gives a determined recognition label for each picture element of the image or each picture element of interest based on a learned model that determines one recognition label from a plurality of types of recognition labels indicating the recognition result as the recognition result.
(5) The information processing apparatus according to any of (1) to (4), wherein the recognition unit gives a recognition label indicating the recognition result as the recognition result, the classification unit gives a category label indicating the classification result as the classification result, and a type of the category label is less than a type of the recognition label.
(6) The information processing apparatus according to (5), wherein the classification unit generates a category label map having the category label for each picture element of the image or each picture element of interest, and the three-dimensional point cloud generation unit gives the category label for each point of the three-dimensional point cloud based on the category label map.
(7) The information processing apparatus according to (5) or (6), wherein the classification unit selects one category label information from the category label information for each task indicating a relationship between the recognition label and the category label, and gives the category label for each picture element of the image or each picture element of interest based on the selected category label information.
(8) An information processing method comprising: executing recognition processing on an image and giving a recognition result for each picture element of the image or each picture element of interest; classifying the recognition result for each picture element of the image or each picture element of interest according to a task and giving a classification result for each picture element of the image or each picture element of interest; and generating a three-dimensional point cloud related to the image and giving the classification result for each point of the three-dimensional point cloud based on the classification result for each picture element of the image or each picture element of interest.
(9) An information generation method comprising: generating information including position information for each point of three-dimensional point cloud, and a classification result for each point of the three-dimensional point cloud acquired by classifying a recognition result for each point of the three-dimensional point cloud according to a task.
(10) An information processing system including the information processing apparatus according to any one of (1) to (7).
(11) An information processing method using the information processing apparatus according to any one of (1) to (7).
(12) An information generation method using the information processing apparatus according to any one of (1) to (7).
(13) A system for generating three-dimensional (3D) point cloud data, the system comprising: at least one first processor configured to: generate, based on two-dimensional (2D) image data, the 3D point cloud data, wherein each point of the 3D point cloud data comprises: position information, the position information comprising at least three coordinates indicating a position of the point; object information labeling the point as a first object selected from a plurality of objects; and category information labeling the point as belonging to a first category of a plurality of categories, wherein each of the plurality of categories comprises at least one respective object of the plurality of objects.
(14) The system of (13) wherein the plurality of categories are defined based on a task.
(15) The system of any of (13) to (14), wherein a number of the plurality of categories is less than a number of the plurality of objects.
(16) The system of any of (13) to (15), further comprising a memory that stores a table comprising a label for each of the plurality of categories and a label for each of the plurality of objects.
(17) The system of any of (13) to (16), wherein the at least one first processor is further configured to: receive the 2D image data; perform 2D object recognition processing on the 2D image data to generate labeled 2D image data including the object information; classify the labeled 2D image data to generate classified 2D image data including the category information; and convert the classified 2D image data to generate the 3D point cloud data including the position information, the object information, and the category information.
(18) The system of (17), wherein the at least one first processor is configured to perform the 2D object recognition processing at least in part using a machine learning model.
(19) The system of (17), wherein the at least one first processor is configured to classify the labeled 2D image data using a machine learning model.
(20) The system of any of (13) to (19), wherein the 2D image data comprises a plurality of 2D image data including a first set of 2D image data and a second set of 2D image data, wherein a field of view of the first set of 2D image data at least partially overlaps with a field of view of the second set of 2D image data, and the at least one processor is configured to generate the 3D point cloud data based on the plurality of 2D image data.
(21) The system of (20), wherein the at least one first processor is further configured to receive depth image data, a field of view of the depth image data at least partially overlaps with a field of view of the 2D image data.
(22) The system of (21). wherein the depth image data is generated by a depth sensor.
(23) The system of (21), wherein the depth image data is generated based on the plurality of 2D image data.
(24) The system of any of (13) to (23), wherein the 2D image data is generated by a camera.
(25) The system of any of (13) to (24), wherein the 2D image data comprises a plurality of pixels and the at least one first processor is further configured to generate a category label map having the category information for each pixel of the 2D image data and wherein the at least one first processor is configured to generate the 3D point cloud data based on the category map.
(26) The system of any of (13) to (25), herein the at least one first processor is further configured to display the 3D point cloud data on a display.
(27) The system of any of (13) to (26), wherein the at least one first processor is configured to display the 3D point cloud data based on a selection of one or more of the plurality of objects and/or a selection of one or more of the plurality of categories.
(28) A method for generating three-dimensional (3D) point cloud data, the method comprising: generating, based on two-dimensional (2D) image data, the 3D point cloud data, wherein each point of the 3D point cloud data comprises: position information, the position information comprising at least three coordinates indicating a position of the point; object information labeling the point as a first object selected from a plurality of objects; and category information labeling the point as belonging to a first category of a plurality of categories, wherein each of the plurality of categories comprises at least one respective object of the plurality of objects.
(29) The method of (28), further comprising: receiving the 2D image data; performing 2D object recognition processing on the 2D image data to generate labeled 2D image data including the object information; classifying the labeled 2D image data to generate classified 2D image data including the category information; and converting the classified 2D image data to generate the 3D point cloud data including the position information, the object information, and the category information.
(30) The method of (29), wherein the performing the 2D object recognition processing is performed at least in part using a machine learning model.
(31) The method of (29) or (30), classifying the labeled 2D image data comprises classifying the labeled 2D image data using a machine learning model.
(32) At least one non-transitory computer-readable storage medium having instructions encoded thereon that, when executed by at least one processor, cause the at least one processor to perform a method for generating three-dimensional (3D) point cloud data, the method comprising: generating, based on two-dimensional (2D) image data, the 3D point cloud data, wherein each point of the 3D point cloud data comprises: position information, the position information comprising at least three coordinates indicating a position of the point; object information labeling the point as a first object selected from a plurality of objects; and category information labeling the point as belonging to a first category of a plurality of categories, wherein each of the plurality of categories comprises at least one respective object of the plurality of objects.
(33) A system comprising: at least one non-transitory computer-readable storage medium having three-dimensional (3D) point cloud data encoded thereon, each point of the 3D point cloud data comprising: position information, the position information comprising at least three coordinates indicating a position of the point; object information labeling the point as a first object selected from a plurality of objects; and category information labeling the point as belonging to a first category of a plurality of categories, wherein each of the plurality of categories comprise at least one respective object of the plurality of objects.

### REFERENCE SIGNS LIST

1 INFORMATION PROCESSING SYSTEM
10 INFORMATION ACQUISITION APPARATUS
20 INFORMATION PROCESSING APPARATUS
21 RECOGNITION UNIT
22 LEARNED MODEL
23 CLASSIFICATION UNIT
24 3D POINT CLOUD GENERATION UNIT
30 SERVER APPARATUS
40 APPLICATION EXECUTION APPARATUS
100 USER TERMINAL
110 DISPLAY UNIT
111 DISPLAY REGION
112 CATEGORY SELECTION GUI
113 TASK SELECTION GUI
500 COMPUTER

1. A system for generating three-dimensional (3D) point cloud data, the system comprising:
at least one first processor configured to:
generate, based on two-dimensional (2D) image data, the 3D point cloud data, wherein each point of the 3D point cloud data comprises:
position information, the position information comprising at least three coordinates indicating a position of the point;
object information labeling the point as a first object selected from a plurality of objects; and
category information labeling the point as belonging to a first category of a plurality of categories, wherein each of the plurality of categories comprises at least one respective object of the plurality of objects.

2. The system of claim 1, wherein the plurality of categories are defined based on a task.

3. The system of claim 1, wherein a number of the plurality of categories is less than a number of the plurality of objects.

4. The system of claim 1, further comprising a memory that stores a table comprising a label for each of the plurality of categories and a label for each of the plurality of objects.

5. The system of claim 1, wherein the at least one first processor is further configured to:
receive the 2D image data;
perform 2D object recognition processing on the 2D image data to generate labeled 2D image data including the object information;
classify the labeled 2D image data to generate classified 2D image data including the category information; and
convert the classified 2D image data to generate the 3D point cloud data including the position information, the object information, and the category information.

6. The system of claim 5, wherein the at least one first processor is configured to perform the 2D object recognition processing at least in part using a machine learning model.

7. The system of claim 5, wherein the at least one first processor is configured to classify the labeled 2D image data using a machine learning model.

8. The system of claim 1, wherein the 2D image data comprises a plurality of 2D image data including a first set of 2D image data and a second set of 2D image data, wherein a field of view of the first set of 2D image data at least partially overlaps with a field of view of the second set of 2D image data, and the at least one processor is configured to generate the 3D point cloud data based on the plurality of 2D image data.

9. The system of claim 8, wherein the at least one first processor is further configured to receive depth image data, a field of view of the depth image data at least partially overlaps with a field of view of the 2D image data.

10. The system of claim 9, wherein the depth image data is generated by a depth sensor.

11. The system of claim 9, wherein the depth image data is generated based on the plurality of 2D image data.

12. The system of claim 1, wherein the 2D image data is generated by a camera.

13. The system of claim 1, wherein the 2D image data comprises a plurality of pixels, and the at least one first processor is further configured to generate a category label map having the category information for each pixel of the 2D image data and wherein the at least one first processor is configured to generate the 3D point cloud data based on the category map.

14. The system of claim 1, wherein the at least one first processor is further configured to display the 3D point cloud data on a display.

15. The system of claim 1, wherein the at least one first processor is configured to display the 3D point cloud data based on a selection of one or more of the plurality of objects and/or a selection of one or more of the plurality of categories.

16. A method for generating three-dimensional (3D) point cloud data, the method comprising:
generating, based on two-dimensional (2D) image data, the 3D point cloud data, wherein each point of the 3D point cloud data comprises:
position information, the position information comprising at least three coordinates indicating a position of the point;
object information labeling the point as a first object selected from a plurality of objects; and
category information labeling the point as belonging to a first category of a plurality of categories, wherein each of the plurality of categories comprises at least one respective object of the plurality of objects.

17. The method of claim 16, further comprising:
receiving the 2D image data;
performing 2D object recognition processing on the 2D image data to generate labeled 2D image data including the object information;
classifying the labeled 2D image data to generate classified 2D image data including the category information; and
converting the classified 2D image data to generate the 3D point cloud data including the position information, the object information, and the category information.

18. The method of claim 17, wherein the performing the 2D object recognition processing is performed at least in part using a machine learning model.

19. The method of claim 17, wherein classifying the labeled 2D image data comprises classifying the labeled 2D image data using a machine learning model.

20. At least one non-transitory computer-readable storage medium having instructions encoded thereon that, when executed by at least one processor, cause the at least one processor to perform a method for generating three-dimensional (3D) point cloud data, the method comprising:
generating, based on two-dimensional (2D) image data, the 3D point cloud data, wherein each point of the 3D point cloud data comprises:
position information, the position information comprising at least three coordinates indicating a position of the point;
object information labeling the point as a first object selected from a plurality of objects; and
category information labeling the point as belonging to a first category of a plurality of categories, wherein each of the plurality of categories comprise at least one respective object of the plurality of objects.

21. A system comprising:
at least one non-transitory computer-readable storage medium having three-dimensional (3D) point cloud data encoded thereon, each point of the 3D point cloud data comprising:
position information, the position information comprising at least three coordinates indicating a position of the point;
object information labeling the point as a first object selected from a plurality of objects; and
category information labeling the point as belonging to a first category of a plurality of categories, wherein each of the plurality of categories comprise at least one respective object of the plurality of objects.
